(19) United States
(12) Patent Application Publication
(10) Pub. No.: US 2025/0183970 A1
(43) Pub. Date: Jun. 5, 2025

(54) METHOD, DEVICE AND COMPUTER PROGRAM PRODUCT FOR WIRELESS COMMUNICATION

(71) Applicant: ZTE Corporation, Shenzhen (CN)

(72) Inventors: Xiaoying MA, Shenzhen (CN); Mengzhu CHEN, Shenzhen (CN); Jun XU, Shenzhen (CN); Bo DAI, Shenzhen (CN); Hong TANG, Shenzhen (CN); Qiujin GUO, Shenzhen (CN); Ping WEI, Shenzhen (CN)

(21) Appl. No.: 19/049,895

(22) Filed: Feb. 10, 2025

Related U.S. Application Data
(63) Continuation of application No. PCT/CN2022/111909, filed on Aug. 11, 2022.

(51) Int. Cl. H04B 7/06; H04W 24/10; H04W 72/0453

(52) U.S. Cl. CPC H04B 7/0626; H04W 24/10; H04W 72/0453

(57) ABSTRACT

A wireless communication method is disclosed. The method comprises: receiving, by a wireless communication terminal from a wireless communication node, control signaling comprising one or more channel state information reference signal, CSI-RS, configuration information associated with one or more group identifiers, IDs, or one or more channel state information, CSI, measurement report configurations associated with one or more group IDs; receiving, by the wireless communication terminal from the wireless communication node, first signaling comprising a CSI-RS configuration indication; and performing, by the wireless communication terminal, at least one of a CSI-RS measurement or a transmission of a channel state information, CSI, measurement report to the wireless communication node based on at least one of the control signaling, the CSI-RS configuration indication, or predefined information.

### CROSS-REFERENCE TO RELATED APPLICATIONS

This application is a continuation of International Patent Application No. PCT/CN2022/110909, filed Aug. 11, 2022, the disclosure of which is incorporated herein by reference in its entirety.

### TECHNICAL FIELD

This document is directed generally to wireless communications, and in particular to 5th generation (5G) or 6th generation (6G) wireless communication.

### BACKGROUND

With the development of wireless communication technology, the transmission rate, throughput, reliability and other performance indices of wireless communication systems have been greatly improved by using high frequency bands, large bandwidths, multi-antennas and other technologies. Meanwhile, greenhouse gas emission caused by the base stations and large power consumption have become an issue with the deployment of 5G. Therefore, network energy saving is important not only for a green communication system but also for a reduction of the operation expense.

This document relates to methods, systems, and devices for a CSI measurement and report.

### SUMMARY

One aspect of the present disclosure relates to a wireless communication method. In an embodiment, the wireless communication method includes: receiving, by a wireless communication terminal from a wireless communication node, control signaling comprising one or more channel state information reference signal, CSI-RS, configuration information associated with one or more group identifiers, IDs, or one or more channel state information, CSI, measurement report configurations associated with one or more group IDs; receiving, by the wireless communication terminal from the wireless communication node, first signaling comprising a CSI-RS configuration indication; and performing, by the wireless communication terminal, at least one of a CSI-RS measurement or a transmission of a channel state information, CSI, measurement report to the wireless communication node based on at least one of the control signaling, the CSI-RS configuration indication, or predefined information.

Another aspect of the present disclosure relates to a wireless communication method. In an embodiment, the wireless communication method includes: transmitting, by a wireless communication node to a wireless communication terminal, control signaling comprising one or more channel state information reference signal, CSI-RS, configuration information associated with one or more group identifiers, IDs, or one or more channel state information, CSI, measurement report configurations associated with one or more group IDs; transmitting, by the wireless communication node to the wireless communication terminal, first signaling comprising a CSI-RS configuration indication; and receiving, by the wireless communication node from the wireless communication terminal, a channel state information, CSI, measurement report to the wireless communication node based on at least one of the control signaling, the CSI-RS configuration indication, or predefined information.

Another aspect of the present disclosure relates to a wireless communication terminal. In an embodiment, the wireless communication terminal includes a communication unit and a processor. The processor is configured to: receive, from a wireless communication node, control signaling comprising one or more channel state information reference signal, CSI-RS, configuration information associated with one or more group identifiers, IDs, or one or more channel state information, CSI, measurement report configurations associated with one or more group IDs; receive, from the wireless communication node, first signaling comprising a CSI-RS configuration indication; and perform at least one of a CSI-RS measurement or a transmission of a channel state information, CSI, measurement report to the wireless communication node based on at least one of the control signaling, the CSI-RS configuration indication, or predefined information.

Another aspect of the present disclosure relates to a wireless communication node. In an embodiment, the wireless communication node includes a communication unit and a processor. The processor is configured to: transmit, to a wireless communication terminal, control signaling comprising one or more channel state information reference signal, CSI-RS, configuration information associated with one or more group identifiers, IDs, or one or more channel state information, CSI, measurement report configurations associated with one or more group IDs; transmit, to the wireless communication terminal, first signaling comprising a CSI-RS configuration indication; and receive, from the wireless communication terminal, a channel state information, CSI, measurement report to the wireless communication node based on at least one of the control signaling, the CSI-RS configuration indication, or predefined information.

Various embodiments may preferably implement the following features:

Preferably, the control signaling comprises at least one of Radio Resource Control, RRC, signaling or Medium Access Control Control Element, MAC CE, signaling.

Preferably, the one or more group IDs is associated with at least one of: the CSI-RS configuration information, a CSI measurement report configuration, a CSI resource configuration, a CSI measurement configuration, a CSI-RS resource set, a CSI-RS resource, or a CSI-RS resource mapping.

Preferably, the one or more group IDs is associated with at least one of periodic CSI-RS configuration information, aperiodic CSI-RS configuration information, or semi-persistent CSI-RS configuration information.

Preferably, the one or more group IDs is associated with at least one of:
a periodic CSI measurement report, an aperiodic CSI measurement report, or a semi-persistent CSI measurement report;
report quantities of at least one of: none, cri-RI-PMI-CQI, cri-RI-i1, cri-RI-i1-CQI, pdsch-BundleSizeForCSI, cri-Ri-CSI, cri-RSRP, ssb-Index-RSRP, or cri-RI-LI-PMI-CQI; or
the CSI measurement report configuration for at least one of: a channel measurement, an interference measurement, a rate matching, or an intra cell interference measurement.

Preferably, group IDs in the one or more group IDs associated with CSI-RS resources in one CSI-RS resource set are the same.

Preferably, group IDs in the one or more group IDs associated with a CSI-RS configuration which is associated with the same CSI measurement report configuration are the same.

Preferably, CSI-RS configurations associated with different group IDs in the one or more group IDs have a hierarchical relationship therebetween.

Preferably, at least one of a first time and frequency domain resource, a first CDM group, a first density, or a first CDM group index for a first CSI-RS configuration corresponding to a first group ID in the one or more group IDs is a subset of at least one of a second time and frequency domain resource, a second CDM group, a second density, or a second CDM group index for a second CSI-RS configuration corresponding to a second group ID in the one or more group IDs.

Preferably, the first CSI-RS configuration corresponding to the first group ID is associated with a first port number, the second CSI-RS configuration corresponding to the second group ID is associated with a second port number, and the first port number is less than the second port number.

Preferably, a time and frequency domain resource for a CSI-RS configuration corresponding to a root group ID is a union set of time and frequency domain resources for CSI-RS configurations of the CSI-RS configuration information corresponding to every group, and the root group ID is associated with a maximum port number of the CSI-RS configuration information.

Preferably, a power control offset for a first CSI-RS configuration corresponding to a first group ID in the one or more group IDs is less than a power control offset for a second CSI-RS configuration corresponding to a second group ID in the one or more group IDs.

Preferably, the first signaling indicates a CSI-RS configuration indication, the CSI-RS configuration indication comprises at least one of: a group ID indication, a group activation or deactivation indication, a base station state indication, an antenna number indication, an aperiodic CSI-RS resource activation indication, an aperiodic CSI measurement report activation indication, or a semi-persistent CSI-RS resource activation indication.

Preferably, the first signaling comprises at least one of: common downlink control information, DCI, dedicate DCI, broadcast DCI, multicast DCI, an MAC CE, or a system information block, SIB.

Preferably, the first signaling comprises an indicating field for one or more user equipments, UEs.

Preferably, the indicating field indicates a group ID, or one or more activations or deactivations of the one or more group IDs.

Preferably, the indicating field comprises a bitmap or a codepoint, and at least one of a bitwidth or a position of the indicating field is determined according to at least one of high layer signaling or a predetermined value. Preferably, a predetermined value is same as a predefined value.

Preferably, the CSI-RS configuration indication in the common DCI, the dedicate DCI, the broadcast DCI, or the multicast DCI is for at least one of a semi-persistent CSI-RS resource or an aperiodic CSI-RS resource.

Preferably, the dedicate DCI or MAC CE comprises a field indicating a triggering or an activation of the CSI measurement report or a CSI-RS configuration, the CSI measurement report or the CSI-RS configuration is associated with one of the one or more group IDs, and the other CSI measurement report configurations or the other CSI-RS configurations associated with the one of the one or more group IDs are implicitly indicated or activated by the field.

Preferably, the MAC CE comprises at least one of: the CSI-RS configuration indication, a field indicating one or more activations or deactivations of the one or more group IDs, a serving cell ID, a bandwidth part, BWP, ID, or one or more indicated group IDs.

Preferably, the predefined information comprises at least one of: one or more timers, a predefined pattern, or a base station state.

Preferably, one of the one or more timers corresponding to one of the one or more group IDs starts in response to a corresponding group being activated.

Preferably, a group is activated in response to the timer expires.

Preferably, the predefined pattern comprises at least one of: a cycle pattern, a Time Division Duplex, TDD, pattern, or a configured pattern.

Preferably, the wireless communication terminal performs at least one of the following operations:
applying, validating or activating the CSI-RS configuration information after a time period relative to the reception of the first signaling;
performing the CSI-RS measurement based on the CSI-RS configuration information after a first time period relative to the reception of the first signaling;
performing the transmission of the CSI measurement report based on the CSI-RS configuration information after a second time period relative to the reception of the first signaling;
changing an activated group according to the predefined information, wherein a corresponding group is applied, validated, or activated after a third time period relative to the change of the activated group;
performing a CSI-RS measurement according to the CSI-RS configuration information in the corresponding group after a fourth time period relative to the change of the activated group; or
performing a transmission of a CSI measurement report for the CSI-RS configuration information or CSI measurement report configuration in the corresponding group after a fifth time period.

Preferably, at least one of the time period, the first time period, the second time period, the third time period, the fourth time period or the fifth time period is associated with at least one of: a predefined value, a time domain behavior, a UE capability, a system frame number, SFN, a Subcarrier Spacing, SCS, an acknowledgement, ACK, a physical uplink shared channel, PUSCH, processing time, a CSI computation time, a frequency range, FR, type, a bandwidth part, BWP, switching delay, a high layer signaling, or a physical uplink shared channel, PDSCH, processing time.

Preferably, at least one of the time period, the first time period, the second time period, the third time period, the fourth time period or the fifth time period is predetermined or associated with a time domain behavior of a CSI-RS resource or a time domain behavior of the CSI measurement report.

Preferably, during at least one of the time period, the first time period, the second time period, the third time period, the fourth time period or the fifth time period, the wireless communication terminal does not perform a CSI-RS measurement for a CSI-RS configuration not applied, validated, or activated after the time period, after the first time period, after the fourth time period, or after the third time period.

Preferably, during at least one of the time period, the first time period, the second time period, the third time period, the fourth time period or the fifth time period, the wireless communication terminal does not transmit a CSI measurement report.

Preferably, when the CSI-RS configuration indication indicates a group ID that the wireless communication terminal is not configured with, the wireless communication terminal ignores the CSI-RS configuration indication, or performs the measurement based on a baseline group, or performs the transmission of the CSI measurement report based on a baseline group.

Preferably, the baseline group is a predetermined group or a group associated with a maximum port number or a root group.

Preferably, the CSI-RS configuration indication is not valid for a CSI resource configuration, a CSI-RS resource set, CSI-RS configuration information, or a CSI-RS resource not associated with the one or more group IDs.

Preferably, the CSI-RS configuration indication is valid when the CSI-RS configuration information in a group which activated by the CSI-RS configuration indication is for at least one of: channel measurement, interference measurement, rate matching, or intra cell interference measurement.

Preferably, the CSI-RS configuration indication is valid when the time domain behavior of the CSI-RS configuration information or CSI measurement report configurations in a group which activated by the CSI-RS configuration indication is at least one of: aperiodic, semi-persistent, or periodic.

Preferably, one of the CSI measurement report configurations and a corresponding configuration in the CSI-RS configuration information are activated correspondingly.

Preferably, the wireless communication terminal transmits at least one of the following to the wireless communication node: whether the wireless communication terminal supports a group ID indication, whether the wireless communication terminal supports a CSI-RS configuration indication by DCI, whether the wireless communication terminal supports CSI-RS configuration information or CSI report configuration group changes according to the predefined information, whether the wireless communication terminal supports a CSI-RS configuration indication by a MAC CE, whether the wireless communication terminal supports a CSI-RS configuration indication, whether the wireless communication terminal supports to be configured with the one or more group IDs, a support number of the one or more group IDs, a maximum number of groups which are supported, or number of ports number types able to be reported at the same time or same slot.

Preferably, the wireless communication terminal transmits at least one of the following to the wireless communication node: a preferred group, a preferred number of groups, a preferred maximum number of groups, a preference of falling to a baseline group or a root group, a preferred port number, a preferred port number list, a preferred maximum port number, a preference of falling back to a baseline CSI-RS configuration.

Preferably, the first signaling or a group changing is enabled when at least one of the following events occurs:
Radio Resource Control, RRC, signaling is configured to enable the first signaling;
a group ID is configured;
RRC signaling is configured to enable a change of an activated group according to a predefined information;
a predefined information is configured; or
RRC signaling enabling a group indication is enabled.

Preferably, the first signaling is enabled comprises at least one of: the wireless communication node is able to transmit the first signaling to the wireless communication terminal; the wireless communication terminal monitors the first signaling; or an indicating field indicating an activation or deactivation of the one or more group IDs exists in the first signaling.

Preferably, the wireless communication node receives at least one of the following from the wireless communication terminal: whether the wireless communication terminal supports a group ID indication, whether the wireless communication terminal supports a CSI-RS configuration indication by DCI, whether the wireless communication terminal supports CSI-RS configuration information or CSI report configuration group changes according to the predefined information, whether the wireless communication terminal supports a CSI-RS configuration indication by a MAC CE, whether the wireless communication terminal supports a CSI-RS configuration indication, whether the wireless communication terminal supports to be configured with the one or more group IDs, a support number of the one or more group IDs, a maximum number of groups which are supported, or number of ports number types able to be reported at the same time or same slot.

Preferably, the wireless communication node receives at least one of the following from the wireless communication terminal: a preferred group, a preferred number of groups, a preferred maximum number of groups, a preference of falling to a baseline group or a root group, a preferred port number, a preferred port number list, a preferred maximum port number, a preference of falling back to a baseline CSI-RS configuration.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a CSI resource configuration according to an example.

FIG. 2 shows RRC signaling including a group index according to an embodiment.

FIG. 3 shows RRC signaling including a group index according to an embodiment.

FIG. 4 shows a schematic diagram of configuration information according to an embodiment.

FIG. 5 shows a schematic diagram of configuration information according to an embodiment.

FIG. 6 shows a schematic diagram of configuration information according to an embodiment.

FIG. 7A shows a table of CSI-RS configuration indication for serving cells according to an embodiment.

FIG. 7B shows a table of serving cells and group ID/index activation/de-activation indication according to an embodiment.

FIG. 8 shows an example of a schematic diagram of a wireless terminal according to an embodiment of the present disclosure.

FIG. 9 shows an example of a schematic diagram of a wireless network node according to an embodiment of the present disclosure.

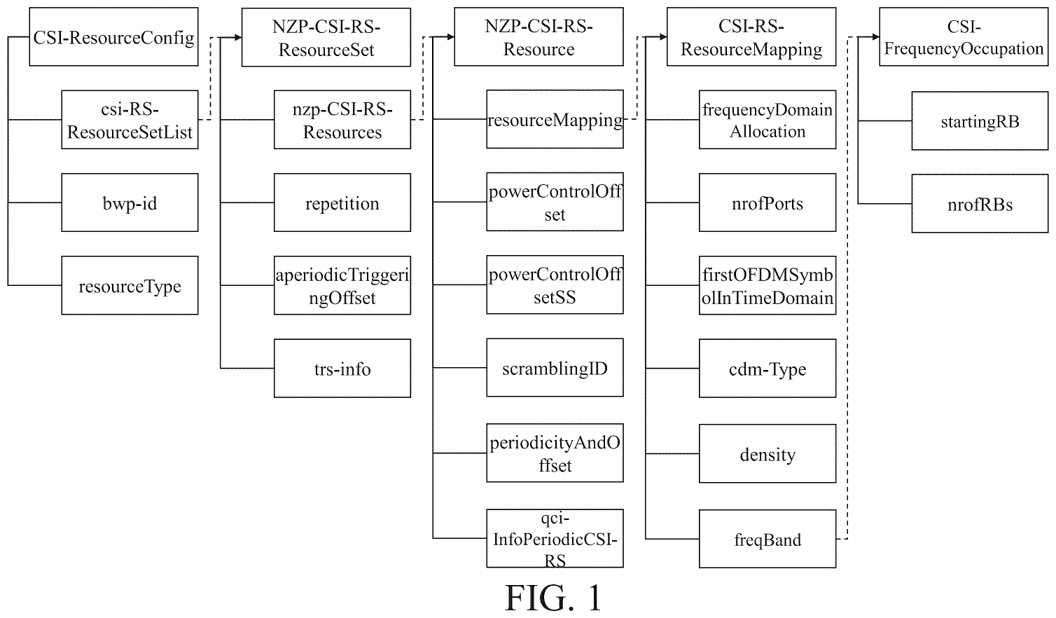

FIG. 1 shows a schematic diagram of a CSI resource configuration according to an example.

### DETAILED DESCRIPTION

In a CSI (channel state information) measurement, a UE (user equipment) may perform measurements based on CSI-RS (reference signal) and may report corresponding report to gNB.

CSI-RS: The CSI-RS may be used for time/frequency tracking, CSI computation, L1 (layer 1)-RSRP (reference signal received power) computation, L1-SINR (signal-to-noise and interference ratio) computation, mobility, and tracking during fast SCell (secondary cell) activation.

CSI: The time and frequency resources that can be used by the UE to report CSI are controlled by the gNB. CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), LI-RSRP, L1-SINR or Capability [Set] Index.

CSI-RS resource: Each CSI Resource Setting CSI-ResourceConfig contains a configuration of a list of S>1 CSI Resource Sets (given by higher layer parameter CSI-RS-ResourceSetList), where the list is comprised of references to either or both of NZP (non zero power) CSI-RS resource set(s) and SS/PBCH block set(s) or the list is comprised of references to CSI-IM (interference measurement) resource set(s). Each CSI Resource Setting is located in a DL (downlink) BWP (bandwidth part) identified by the higher layer parameter BWP-id, and CSI Resource Settings linked to a CSI Report Setting have the same DL BWP. The time domain behavior of the CSI-RS resources within a CSI Resource Setting are indicated by the higher layer parameter resource Type and can be set to aperiodic, periodic, or semi-persistent.

CSI report: Each Reporting Setting CSI-ReportConfig is associated with a single downlink BWP (indicated by higher layer parameter BWP-Id) given in the associated CSI-ResourceConfig for channel measurement. The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, LI-RSRP-related, LI-SINR-related or Capability [Set] Index-related quantities to report.

For aperiodic CSI-RS report, RRC configures a CSI-AperiodicTriggerStateList, This List includes a list of associatedReportConfigInfoList, the associatedReportConfigInfoList indicates multiple CSI report configurations (also referred to as CSI measurement report configurations). A DCI can trigger one entry in the CSI-AperiodicTriggerStageList. UE may measure CSI and report CSI according to the triggered entry.

For semi-persistent reporting on PUSCH, a set of trigger states are configured by a higher layer signal CSI-SemiPersistentOnPUSCH-TriggerStateList, where a CSI request field in DCI scrambled with SP-CSI-RNTI activates one of the trigger states. A UE is not expected to receive a DCI scrambled with SP-CSI-RNTI activating one semi-persistent CSI report with the same CSI-ReportConfigId as in a semi-persistent CSI report which is activated by a previously received DCI scrambled with SP-CSI-RNTI. A semi-persistent CSI measurement report may include a semi-persistent on PUSCH CSI measurement report or a semi-persistent on PUCCH CSI measurement report.

For semi-persistent reporting on PUCCH, the PUCCH resource used for transmitting the CSI report are configured by reportConfigType. Semi-persistent reporting on PUCCH is activated by an activation command of MAC CE.

The number of ports of a CSI-RS is configured by nrofPorts in CSI-ResourceMapping, CSI-ResourceMapping is associated with an NZP-CSI-RS-Resource. The nrofPorts can be one of the following: p1, p2, p4, p8, p12, p16, p24, p32, in which p1 indicates one port, p2 indicates two ports, p8 indicates eight ports, and so on.

If the number of base station antenna changes, the number of CSI-RS port may also need to change. For example, a base station with 4 antennas can support 4 port CSI-RS, if the number of antennas decreased to 2 antennas, the base station cannot support 4 port CSI-RS. Therefore, UE performs CSI-RS measurement with different number of ports should be supported. And the number of CSI-RS port used may changes according to the change of number of base station antennas. In the prior art, most CSI-RS resource settings are configured by RRC (Radio Resource Control) signaling, and are a UE specific configuration. The RRC signaling overhead may be high if the gNB wants to change the number of CSI-RS ports for the UEs in the cell. Therefore, a new indication method of CSI-RS setting should be considered.

In some embodiments, to reduce the power consumption of a gNB, the number of antennas or antenna ports may be changed or reduced. In some embodiment, CSI measurement or CSI reporting may also changes corresponding to the change of number of antennas or antenna ports.

In some embodiments, the UE may perform one or more of the operations below, but does not limit thereto.

Receiving, a RRC signaling, the RRC signaling includes at least a CSI-RS configuration information, the CSI-RS configuration includes a group ID/index.

Receiving, a first signaling, the first signaling includes a CSI-RS configuration indication.

Performing, measurements and CSI report according to the RRC signaling and/or the first signaling and/or a predefined information.

### Example 1: RRC Signaling Includes a Group Index

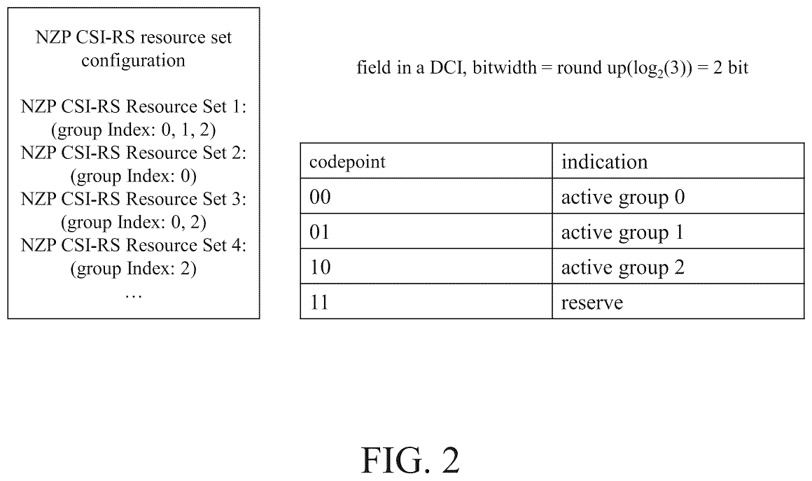

FIG. 2 shows RRC signaling including a group index according to an embodiment.

In this example, the CSI-RS configuration information is a CSI-RS resource set. The UE is configured with a CSI-RS resource set associated with zero, one or more group index. The first signaling is a DCI. A field of X bits in the DCI is used to indicate a group index. The bitwidth X of the field is determined based on the configured group number. Each codepoint indicates one group index. For example, bit ‘00’ means activate the group 0 and de-active the other groups, bit ‘01’ means active the group 1 and de-active the other groups, bit ‘10’ means active the group 2 and de-active the other groups etc. If the UE receives the DCI, the CSI-RS resource sets associated with the indicated group index are valid/activated and the CSI-RS resource sets associated with other group indices are invalid/de-activated.

### Example 2: RRC Signaling Includes a Group Index

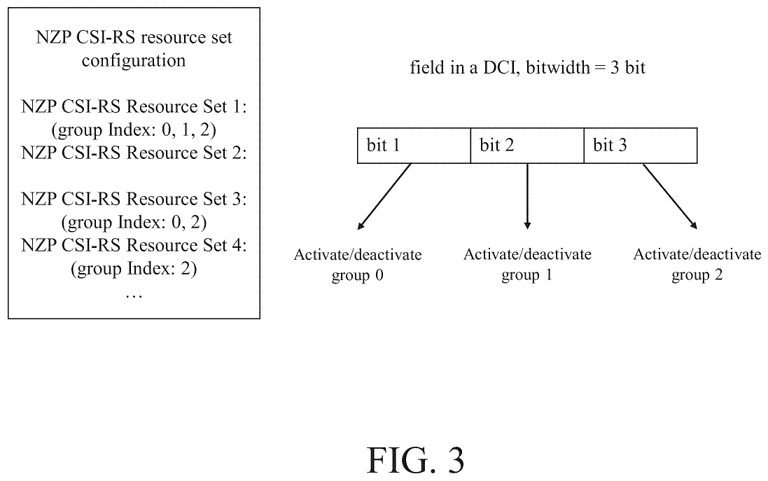

FIG. 3 shows RRC signaling including a group index according to an embodiment.

In this example, the CSI-RS configuration information is a CSI-RS resource set. The UE is configured with a CSI-RS resource set associated with zero, one or more group index. The first signaling is a DCI. A field of X bits in the DCI is used to indicate a group activation/de-activation. The bitwidth of the field is determined same as the configured group number. Each bit indicates activation/de-activation of a group. bit value ‘0’ means de-activate the corresponding group, bit value ‘1’ means activate the corresponding group. If UE receives the DCI, the CSI-RS resource sets associated with the active group are valid/activated and the CSI-RS resource sets associated with de-activated group are invalid/de-activated. UE performs measurements and CSI report according to the valid/activated CSI-RS resource set.

The meaning of a CSI-RS configuration being valid/activated in some embodiments is described below, but not limited thereto.

In some embodiments, the CSI-RS configurations are valid/activated means the UE performs measurements according to the valid/activated CSI-RS configurations.

In some embodiments, the CSI-RS configurations are invalid/de-activated means the UE does not perform measurements according to the invalid/de-activated CSI-RS configurations.

In some embodiments, does not transmit the CSI measurement report means does not transmit the CSI report on the PUCCH or PUSCH of the CSI report configuration. In some embodiments, does not transmit the CSI measurement report means does not transmit the CSI report generated according to a CSI report configuration.

In some embodiments, for periodic CSI-RS configuration, the CSI-RS configuration is valid/activated means at least one of the following:
The UE can measure on the valid/activated periodic CSI-RS configuration;
Ignoring the indication; and/or
Activating the periodic CSI-RS configuration if the periodic CSI-RS resource is not activated. In other words, the UE can measure on the periodic CSI-RS configuration no matter whether it is activated before.

In some embodiments, for periodic CSI-RS configuration, the CSI-RS configuration is invalid/de-activated means at least one of the following:
The UE stops measuring on the invalid/de-activated periodic CSI-RS configuration;
Ignoring the indication; and/or
Releasing/de-activating the periodic CSI-RS configuration.

In some embodiments, for semi-persistent CSI-RS configuration, the CSI-RS configuration is valid/activated means at least one of the following:
The UE can measure on the valid/activated semi-persistent CSI-RS configuration if the semi-persistent CSI-RS configuration has already been activated by a MAC CE or a DCI. In the prior art, a semi-persistent CSI-RS resource can be activated by a MAC CE. In this embodiment, the valid/activated (or invalid/de-activated) indication carried by a first signaling is used for the semi-persistent CSI-RS resource which has already activated by the prior art method.
Ignoring the indication; and/or
The UE can measure on the semi-persistent CSI-RS configuration whether the semi-persistent CSI-RS configuration has been activated by MAC CE or not. In other words, an invalid/de-activated semi-persistent CSI-RS resource can be valid/activated. In this embodiment, the valid/activated (or invalid/de-activated) indication carried by a first signaling is used for all the semi-persistent CSI-RS resource or CSI report which is configured no matter whether or not it has been activated by the prior art method.

In some embodiments, for semi-persistent CSI-RS configuration, the CSI-RS configuration is invalid/de-activated means at least one of the following:
The UE does not measure on the semi-persistent CSI-RS configuration;
Ignoring the indication; and/or
Releasing/de-activating the semi-persistent CSI-RS configuration.

In some embodiments, for aperiodic CSI-RS configuration, the CSI-RS configuration is valid/activated means at least one of the following:
The aperiodic CSI-RS configuration can be triggered/activated by another DCI. In another words, a valid/activated aperiodic CSI-RS configuration is a CSI-RS configuration which can be selected to be used but not used yet.
The UE can measure on the valid/activated aperiodic CSI-RS resource; and/or
Ignoring the indication.

In some embodiments, for aperiodic CSI-RS configuration, the CSI-RS configuration is invalid/de-activated means at least one of the following:
An invalid/de-activated aperiodic CSI-RS configuration cannot be triggered/activated by another DCI. In other words, an invalid/de-activated aperiodic CSI-RS configuration cannot be selected to be used; and/or
Ignoring the indication.

In some embodiments, the another DCI described above is a DCI with a CSI request field.

Some aspects of the present disclosure are described below, but the present disclosure is not limited thereto.

### Aspect 1: Configuration Information

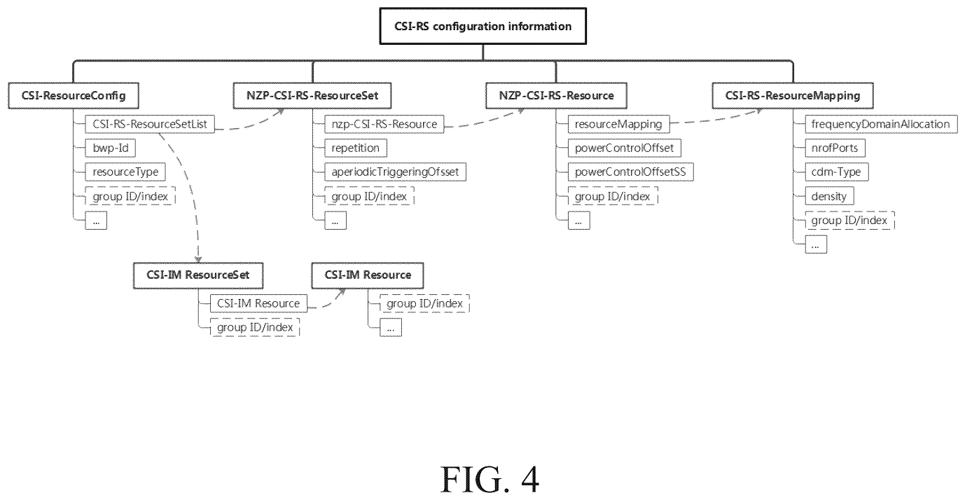

FIG. 4 shows a schematic diagram of configuration information according to an embodiment. As illustrated in FIG. 4, a CSI-ResourceConfig, a NZP CSI-RS ResourceSet, a NZP CSI-RS Resource, a CSI-RS resourceMapping, a CSI-IM-ResourceSet, a CSI-IM-Resource, and/or other configurations in the CSI-RS configuration information may correspond to a group ID/index. Details in this regard will be described below.

In some embodiments, UE may receive a high layer signaling. The high layer signaling may be a MAC CE signaling or a RRC signaling. The high layer signaling includes at least one of the following: a CSI-RS configuration information, a CSI report configuration, and/or a group ID/index.

In some embodiments, the CSI-RS configuration information may include at least one of the following: a CSI-ResourceConfig, a NZP CSI-RS ResourceSet, a NZP CSI-RS Resource, a CSI-RS resourceMapping, a CSI-MeasConfig, ZP-CSI-RS-ResourceSet, ZP-CSI-RS-Resource, and/or CSI-IM-ResourceSet, CSI-IM-Resource.

In some embodiments, a group ID/index may be associated with a CSI-RS configuration information or a CSI report configuration.

In some embodiments, a group ID/index is associated with a CSI-RS configuration information. The group ID/index indicates a group to which a CSI-RS configuration information belongs.

In some embodiments, the group ID/index may be associated with at least one of the following: a CSI-ResourceConfig, a NZP CSI-RS ResourceSet, a NZP CSI-RS Resource, a CSI-RS resourceMapping, ZP-CSI-RS-ResourceSet, ZP-CSI-RS-Resource, CSI-IM-ResourceSet, CSI-IM-Resource, and/or a CSI measurement configuration. For example, the group ID/index is associated with a NZP CSI-RS ResourceSet. One NZP CSI-RS ResourceSet may be configured with a group ID/index 0 and another NZP CSI-RS Resource Set may configured with a resource group ID/index 1.

In some embodiments, the CSI measurement configuration (e.g., CSI-MeasConfig) is used to configure a CSI-RS belonging to the serving cell in which CSI-MeasConfig is included, a channel state information reporting to be transmitted on PUCCH on the serving cell in which CSI-MeasConfig is included, and a channel state information reporting on PUSCH triggered by DCI received on the serving cell in which CSI-MeasConfig is included.

In some embodiments, multiple CSI-ResourceConfig, NZP CSI-RS ResourceSet, NZP CSI-RS Resource, ZP-CSI-RS-ResourceSet, ZP-CSI-RS-Resource, and/or CSI-RS resourceMapping can be associated with a same group ID/index.

In some embodiments, a CSI-MeasConfig, a CSI-ResourceConfig, NZP CSI-RS ResourceSet, NZP CSI-RS Resource, ZP-CSI-RS-ResourceSet, ZP-CSI-RS-Resource, and/or CSI-RS resourceMapping can be associated with one or more group ID/index.

In some embodiments, only a first kind of CSI-RS configuration information can be associated with a group ID/index.

In some embodiments, the first kind of CSI-RS configuration information may be associated with a first kind time domain behavior. The time domain behavior includes aperiodic, periodic, or semi-persistent time behavior. For example, the first kind time domain behavior includes at least aperiodic time behavior. In another example, the first kind of time domain behavior includes at least periodic time behavior.

In some embodiments, a CSI-RS configuration information can be configured without a group ID/index. And the CSI-RS configuration information without a group ID/index are not controlled by a first signaling indication.

In some embodiments, a CSI report configuration may associate with multiple CSI-RS configuration informations (e.g., multiple CSI-ResourceConfig or resourcesForChannelMeasurement), the multiple CSI-RS configuration information associate with different group ID.

In some embodiments, a CSI report configuration may be associated with a group ID/index.

In some embodiments, the CSI report configuration is CSI-ReportConfig.

In some embodiments, only a first kind of CSI report configuration may be associated with a group ID/index.

In some embodiments, the first kind of CSI report configuration may be associated with a first kind of time domain behavior. The time domain behavior can be ‘aperiodic’, ‘semiPersistentOnPUCCH’, ‘semiPersistentOnPUSCH’, and/or ‘periodic’. In some embodiments, the first kind of time domain behavior may include at least ‘aperiodic’ time behavior. In some embodiments, the first kind of time domain behavior may include at least one of the following: ‘semiPersistentOnPUCCH’, ‘semiPersistentOnPUSCH’, and/or ‘periodic’ time behavior. In some embodiments, the first kind of time domain behavior may include at least ‘periodic’ time behavior.

In some embodiments, the first kind of CSI report configuration may be associated with a first kind of report quantity. The report quantity includes ‘none’, ‘cri-RI-PMI-CQI’, ‘cri-RI-i1’, ‘cri-RI-i1-CQI’, ‘pdsch-BundleSizeForCSI’, ‘cri-Ri-CSI’, ‘cri-RSRP’, ‘ssb-Index-RSRP’, and/or ‘cri-RI-LI-PMI-CQI’. In some embodiments, the first kind of report quantity includes at least one of the following: ‘cri-RI-PMI-CQI’, ‘cri-RI-i1’, ‘cri-RI-i1-CQI’, ‘cri-Ri-CSI’, and/or ‘cri-RSRP’.

In some embodiments, the first kind of CSI report configuration may be associated with a first kind of usage. The usage includes Channel Measurement (CSI report configuration configured with resourcesForChannelMeasurement), interference measurement (CSI report configuration configured with csi-IM-ResourcesForInterference), or intra cell interference measurement (CSI report configuration configured with nzp-CSI-RS-ResourcesForInterference). For example, the first kind of usage includes at least channel measurement and intra cell interference measurement.

In some embodiments, a CSI report configuration may be associated with zero or one or more group ID/index.

In some embodiments, one group ID/index may be associated with zero or one or more CSI report configuration.

In some embodiments, trigger/active/valid a CSI report configuration with a group ID means trigger/active/valid the CSI-RS configuration configured to be associated with the CSI report configuration.

In some embodiments, if a semi-persistent CSI-RS configuration is valid/activated by the first signaling or predefined information, the corresponding CSI report configuration is also valid/activated.

In some embodiments, if a CSI-RS configuration is valid/activated, the corresponding CSI report configuration is also valid/activated.

In some embodiments, the group index/ID of a CSI-RS resource in a same CSI-RS resource set should be same.

In some embodiments, the group index/ID of a CSI-RS configuration which are associated with a same CSI report configuration should be same.

In some embodiments, one CSI report configuration (CSI reportConfig) can be associated with CSI-RS configuration configured with different group index/ID.

In some embodiments, there is a hierarchical relationship between groups.

In some embodiments, hierarchical relationship means one group may be considered as a father group. A first kind of configuration of a CSI-RS resource configuration in a son group may be a subset of a CSI-RS resource configuration in the father group or may be same as the father group. In another embodiment, hierarchical relationship means one group may be considered as a father group. A first kind of configuration of the son group(s) may be a subset of the father group or may be same as the father group.

In some embodiments, the son groups can also be considered as a father group and have some son groups.

In some embodiments, the first kind of configuration includes at least one of following: the time and/or frequency resource, CDM type, port number (e.g., number of port(s)), density, CDM group index.

In some embodiments, no CDM is subset of {FD-CDM2, CDM4 (FD2, TB2), CDM8 (FD2, TD4)}, FD-CDM2 is subset of {CDM4 (FD2, TB2), CDM8 (FD2, TD4)}, CDM4 (FD2, TB2) is subset of CDM8 (FD2, TD4).

In some embodiments, a smaller port number is a subset of a larger port number. E.g., port number 4 is a subset of a port number 8.

In some embodiments, a smaller density is a subset of a larger density. E.g., density 0.5 is a subset of a density 1.

In some embodiments, the time and/or frequency resource of a father group (e.g., a root group) is the union set of the time and/or frequency resource of the other groups.

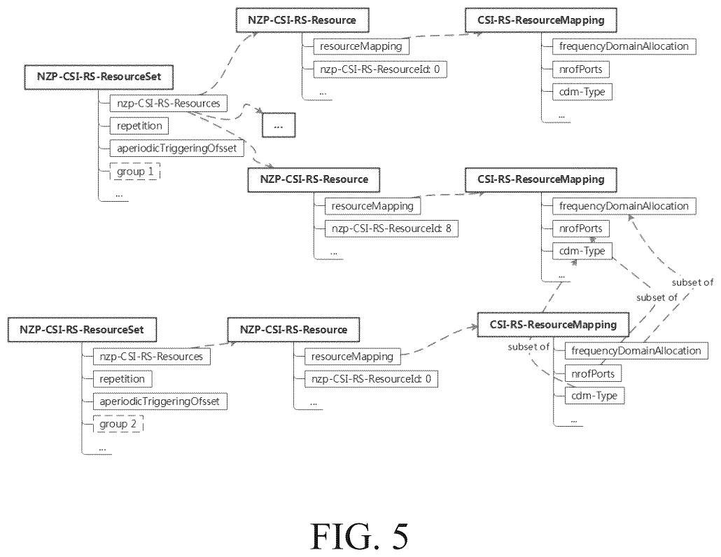

FIG. 5 shows a schematic diagram of configuration information according to an embodiment. As illustrated in FIG. 5, the group ID/index “group 1” may be associated with a first NZP-CSI-RS-ResourseSet, and the group ID/index “group 2” may be associated with a second NZP-CSI-RS-ResourseSet parallel to the first NZP-CSI-RS-ResourseSet.

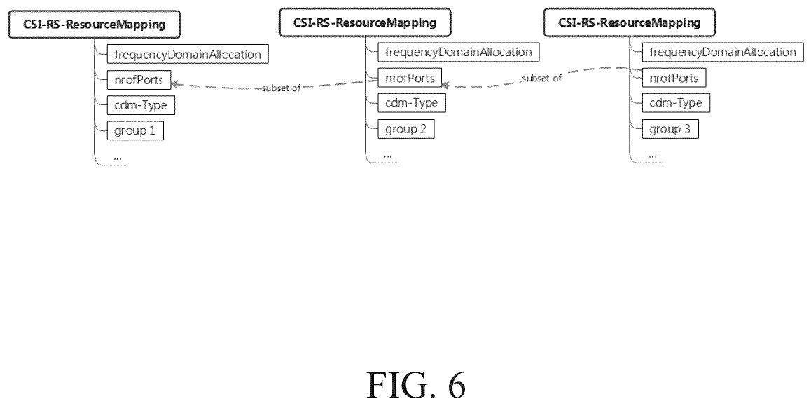

FIG. 6 shows a schematic diagram of configuration information according to an embodiment. As illustrated in FIG. 6, the group ID/index “group 1” may be associated with a first CSI-RS-ResourseMapping, the group ID/index “group 2” may be associated with a second CSI-RS-ResourseMapping, and the group ID/index “group 3” may be associated with a third CSI-RS-ResourseMapping. In this embodiment, group 3 may be the son group of group 2, and the number of ports (e.g., nrofPorts) of the third CSI-RS-ResourseMapping may be a subset of the numbers of ports (e.g., the port numbers) of the second CSI-RS-ResourseMapping. In this embodiment, group 2 may be the son group of group 1, and the number of ports of the second CSI-RS-ResourseMapping may be a subset of the numbers of ports of the first CSI-RS-ResourseMapping. The number of ports of the third CSI-RS-ResourseMapping may be a subset of the first CSI-RS-ResourseMapping.

In some embodiments, the time and/or frequency resource of one group can be a subset of the time and/or frequency resource of another group.

In some embodiments, the time and/or frequency resource of a group with a smaller port configuration is a subset of the time and/or frequency resource of a group with larger port configuration.

In some embodiments, the CDM (code division multiplexing) type of a CSI RS resource in the first group is same as a CSI RS resource in the second group.

In some embodiments, the CDM type includes at least: No CDM, FD-CDM2, CDM4 (FD2, TD2), CDM8 (FD2, TD4).

In some embodiments, if the time and/or frequency resource of a first group is a subset of the time and/or frequency resource of a second group, the CDM (code division multiplexing) type number of a CSI RS resource in the first group is less than a CDM type number of CSI RS resource in the second group.

In some embodiments, the CDM type number is 1 for No CDM, 2 for FD-CDM2, 4 for CDM4 (FD2, TD2), and 8 for CDM8 (FD2, TD4)

In some embodiments, if the time and/or frequency resource of a first group is a subset of the time and/or frequency resource of a second group, the CDM (code division multiplexing) group number of a CSI RS resource in the first group is less than a CDM group number of a CSI RS resource in the second group.

In some embodiments, the CDM group number is derived according to CDM type number and port number. CDM group number=port number/CDM type number. Each CDM group is associated with a CDM group index. The CDM group index is counts from 0 to CDM group number−1.

In some embodiments, if the time and/or frequency resource of a first group is a subset of the time and/or frequency resource of a second group, the CDM (code division multiplexing) group index of a CSI RS resource in the first group is a subset of the CDM group index of the CSI RS resource in second group.

In some embodiments, if the time and/or frequency resource of a first group is a subset of the time and/or frequency resource of a second group, the density of a CSI RS resource in the first group is less than the density of a CSI RS resource in the second group.

In some embodiments, if the time and/or frequency resource of a first group is a subset of the time and/or frequency resource of a second group, the powerControlOffset/powerControlOffsetSS configured for a CSI RS resource in the first group is associated with the powerControlOffset/powerControlOffsetSS configured for a CSI RS resource in the second group. For example, the powerControlOffset/powerControlOffsetSS configured for a CSI RS resource in the first group reduces 10*log₁₀(P1/P2) dB from the powerControlOffset/powerControlOffsetSS configured for a CSI RS resource in the second group, P1 is the port number configured for a CSI RS resource in the second group, P2 is the port number configured for a CSI RS resource in the first group.

In some embodiments, the powerControlOffset/powerControlOffsetSS configured for a CSI RS resource in the first group is associated with the powerControlOffset/powerControlOffsetSS configured for a CSI RS resource in the second group. In some embodiments, the powerControlOffset/powerControlOffsetSS configured for a CSI RS resource in the first group is less than the powerControlOffset/powerControlOffsetSS configured for a CSI RS resource in the second group.

For example, the powerControlOffset/powerControlOffsetSS configured for a CSI RS resource in the first group reduces 10*log₁₀(P1/P2) dB from the powerControlOffset/powerControlOffsetSS configured for a CSI RS resource in the second group, P1 is the port number configured for a CSI RS resource in the second group, P2 is the port number configured for a CSI RS resource in the first group. P1 is larger than P2.

### Aspect 2: First Signaling

In some embodiments, the UE receives a first signaling, the first signaling includes a CSI-RS configuration indication.

In some embodiments, the CSI-RS configuration indication indicated by the first signaling includes at least one of the following: a group ID/index indication, a group activation/de-activation indication, a base station state indication, an antenna number indication, an aperiodic CSI-RS resource activation indication, an aperiodic CSI report activation indication, a semi-persistent CSI-RS resource activation indication.

In some embodiments, the CSI-RS configuration indication implicit or explicit indicates a group ID. In some embodiments, the CSI-RS configuration indication implicit or explicit activate a group or de-active a group.

In some embodiments, the antenna number indication indicates a number of gNB antenna or maximum number of CSI-RS antenna port. Each antenna number may be associated with a group ID, and that is, indicate an antenna number implicit indicate a group ID.

In some embodiments, the group ID/index indication indicates a CSI-RS configuration group used for a UE. The indicated CSI-RS configuration group is valid/activated. CSI-RS configuration group used for a UE means UE can perform measurement according to the CSI-RS configuration which is associated with the indicated group ID/index.

In some embodiments, the base station state indication indicates a base station energy saving information. The base station state indication implicitly indicates a group. For example, Base station have multiple energy saving state, each energy saving state may be associated with a CSI-RS configuration group. If a base station state is indicated, the corresponding CSI-RS configuration group is valid/activated.

In some embodiments, the aperiodic CSI-RS resource activation indication triggers an aperiodic CSI-RS measurement and report. In some embodiments, it can implicitly indicate a group ID/index. For example, if the UE receives a DCI triggering an aperiodic CSI-RS resource, and the aperiodic CSI-RS resource is configured with a group ID/index, then the CSI-RS configuration or CSI report configured with same group ID/index are activated/used. For another example, if UE receives a DCI triggering an aperiodic CSI-RS resource, and the aperiodic CSI-RS resource is configured with a group ID/index, then the CSI-RS resource or CSI report configured with group ID/index which are smaller than or equal to the group ID/index which is triggered are activated/used.

In some embodiments, the semi-persistent CSI-RS resource activation indication may activate a semi-persistent CSI-RS resource. It may also implicitly indicate a group ID/Index. For example, if the UE receives a first signaling (e.g., a MAC CE) it activates a semi-persistent CSI-RS resource, and the semi-persistent CSI-RS resource is configured with a group ID/index. The CSI-RS configuration configured with same group ID/index may also be valid/activated. In another example, if the UE receives a first signaling (e.g., a MAC CE) it activates a semi-persistent CSI-RS resource, and the semi-persistent CSI-RS resource is configured with a group ID/index. The CSI-RS configuration configured with a smaller or a same group ID/index may also be valid/activated.

In some embodiments, if the UE receives a first signaling (e.g., a MAC CE) it activates a semi-persistent CSI-RS resource, and the semi-persistent CSI-RS resource is configured with a group ID/index. The CSI-RS configuration configured with same group ID/index which is semi-persistent CSI-RS may also be valid/activated.

In some embodiments, the first signaling is a DCI (downlink control information).

In some embodiments, the DCI is a group common DCI. Group common DCI means the DCI carries information for one or more UEs. A field in the DCI is used to indicate information for one or more UEs.

In some embodiments, a field of X bits is used to indicate information for one or more UEs. A bitmap or codepoint is used for the field.

In some embodiments, the indicated information is one or more group IDs/indexes, or one or more group ID/index activation/de-activation indications. The group ID/index activation/de-activation is indicated by a bitmap. For example, each bit in the field indicates one group activation/de-activation information. ‘0’ means the group is de-activated, ‘1’ means the group is activated. (e.g., ‘011’ means group 1 and group 2 are activated, group 0 is de-activated.).

In some embodiments, the information is a group ID/index indication information. The group ID/index indication information is indicated by a codepoint.

In some embodiments, the bitwidth of the field is determined based on a high layer signaling.

For one example, the bitwidth of the field is explicitly configured by a high layer signaling.

For another example, the bitwidth of the field is derived according to a high layer signaling (e.g., a high layer signaling indicates a group ID/index set, the configured number of groups is N, then the bitwidth is function (log₂(N)). Function is round up or round down or round).

For another example, the bitwidth of the field is derived according to the configured maximum group ID/index(M). In some embodiments, the bitwidth is function (log₂(M)), Function is round up or round down or round (e.g., a UE configured with group ID/index 0 and 2, the bitwidth is function (log₂(2)), Function is round up or round down or round).

For another example, the bitwidth of the field is derived according to a high layer signaling. The bitwidth is determined to be the same as the number of groups UE configured.

For another example, the bitwidth of the field is derived according to a UE capability. The UE capability may indicate at least one of the following: the maximum group UE supported, the number of group UE supported, the bitwidth UE supported.

In some embodiments, the bitwidth is predefined.

In some embodiments, the position of the field for a UE is configured by a high layer signaling.

In some embodiments, the field indicates the CSI-RS resource according to a bitmap.

In some embodiments, the DCI is a dedicate DCI. Dedicate DCI means the DCI carries information for one UE.

In some embodiments, a field in dedicate DCI is used to indicate the information.

In some embodiments, the bitwidth of the field in dedicate DCI can be determined similar to the embodiments above, and details in this regard will not be described herein.

In some embodiments, the dedicate DCI may be a scheduling DCI or non scheduling DCI. Scheduling DCI is a DCI includes DL assignment or UL grant. Non scheduling DCI is a DCI not including scheduling information.

In some embodiments, the dedicate DCI includes a field indicates triggering/activation of CSI Reports or CSI-RS resources, the field implicitly indicating a group ID/index if the triggered/activated CSI report or CSI-RS resources configured with a group ID/index; otherwise, the field does not implicitly indicate a group ID/index.

In some embodiments, the DCI is a broadcast or multicast DCI.

In some embodiments, the broadcast or multicast DCI is scrambled with at least one of the following RNTI: MCCH-RNTI (Multicast broadcast services control channel RNTI), G-RNTI (Group RNTI), G-CS-RNTI (Group configured scheduling RNTI).

In some embodiments, a field in broadcast or multicast DCI is used to indicate the information.

In some embodiments, the bitwidth of the field in broadcast or multicast DCI can be determined similar to the embodiments above, and details in this regard will not be described herein.

In some embodiments, the DCI is scrambled with a specific RNTI. For example, the specific RNTI is only used for the CSI-RS configuration indication.

In some embodiments, the DCI is scrambled with at least one of the following RNTI: MCCH-RNTI, G-RNTI, G-CS-RNTI.

In some embodiments, the DCI is a specific DCI. For example, the specific DCI is only used for CSI-RS configuration indication.

In some embodiments, the CSI-RS configuration indication indicated by a DCI can only be used to at least a semi-persistent CSI-RS resource or an aperiodic CSI-RS resource which is configured with a group ID/index.

In some embodiments, the first signaling is a MAC CE.

In some embodiments, the MAC CE is scheduled by a broadcast/multicast DCI.

Each field in the MAC CE indicates an activation/de-activation indication for one group.

In some embodiments, the MAC CE is a semi-persistent CSI-RS/CSI-IM Resource Set Activation/Deactivation MAC CE.

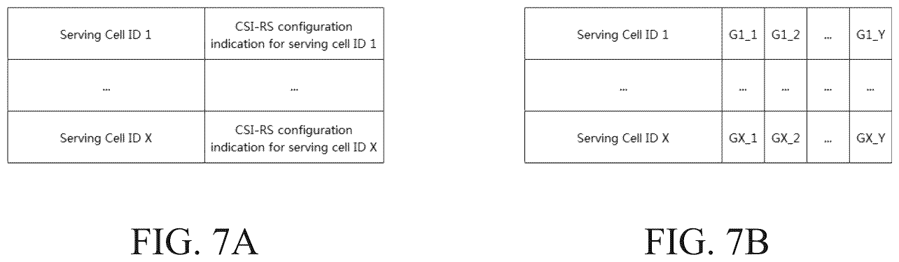

In some embodiments, the MAC CE indicates CSI-RS configuration indication for multiple cells. For example, the MAC CE indicates a serving cell ID first, and followed by the CSI-RS configuration indication for the serving cell (see FIG. 7A).

In some embodiments, the CSI-RS configuration indication may be CSI-RS resource set activation/de-activation indication.

In some embodiments, the CSI-RS configuration indication may be a group ID/index indication, a group ID/index activation/de-activation indication, an antenna number indication, a base station state indication, an aperiodic CSI-RS resource activation indication, a semi-persistent CSI-RS resource activation/deactivation indication, or an aperiodic CSI report activation indication for the serving cell.

In another example, the MAC CE indicates a serving cell ID first, and followed by group ID/index activation/de-activation indication (GX_Y: group Y in serving cell X activation/de-activation indication) for each group in the serving cell (See FIG. 7B).

In some embodiments, the MAC CE includes at least one of the following:
the CSI-RS configuration indication;
a field indicates whether to activate or deactivate indicated group ID, for example, the field is set to 1 to indicate activation, otherwise it indicates deactivation;
a serving cell ID, this field indicates the identity of the Serving Cell for which the MAC CE applies;
a BWP ID, this field indicates a DL BWP for which the MAC CE applies; and/or
a group ID, indicating the group, which shall be activated or deactivated.

In some embodiments, the first signaling is a SIB (system information block).

### Aspect 3: Predefined Information

In some embodiments, the UE may perform, measure and/or transmit the CSI report according to the RRC signaling and a predefined information. In some embodiments, the predefined information includes at least one of the following: a timer, a predefined pattern, a base station state.

In some embodiments, the predefined information includes a timer. The timer can be used to change the activated group. For example, the UE will change to another group when the timer is expired.

In some embodiments, the timer value is configured by a RRC signaling. In some embodiments, the timer value is indicated by a DCI or MAC CE.

In some embodiments, the timer is start or restart when a specific group is activated. In some embodiments, the specific group is a son group or a group other than the baseline group.

In some embodiments, the timer is started or restarted when the UE receives a DL assignment or a UL grant.

In some embodiments, the timer is running when a baseline group is activated. In some embodiments, the baseline group is a father group or a predefined group or a group associated with maximum port number or a group 0.

In some embodiments, the UE will change to a baseline group when the timer is expired.

In some embodiments, the UE will change to a group with index−1 when the timer is expired (e.g., UE changes from group 2 to group 1 after the timer expires, and changes to group 0 after another timer expires).

In some embodiments, the UE will change to a group with index+1 when the timer is expired.

In some embodiments, the timer value is configured per group (e.g., each group can be associate with a timer). In some embodiments, a son group can be associate with a timer.

In some embodiments, the predefined information includes a predefined pattern.

In some embodiments, the predefined pattern includes at least one of the following: a cycle pattern, a TDD pattern, a configured pattern.

In some embodiments, the predefined pattern is a cycle pattern. When and which group will be activated/de-activated are determined by the cycle pattern. For example, first group may be activated/valid for a first cycle, after the first cycle, a second group may be activated/valid for a second cycle, after the second cycle, a third group may be activated/valid for a third cycle, and so on. Until all the group are activated/valid for a cycle, the first group is activated/valid again. In one cycle, only one group will be activated/valid, the other groups are invalid/de-activated.

In some embodiments, the cycle may be configured by an RRC signaling. The units of cycle may be SF (system frame), slot, millisecond, frame, subframe.

In some embodiments, the predefined pattern is a TDD pattern. The activated/valid group may change every TDD pattern. The TDD pattern may configured by tdd-UL-DL-ConfigurationCommon high layer signal.

In some embodiments, the predefined pattern is a configured pattern, different group may be activated/valid for different time duration. One or more groups may be activated/valid for a same time duration. The configured pattern indicates the time durations. In some embodiments, the configured pattern is configured by a RRC signaling.

In some embodiments, the predefined information includes a base station state.

In some embodiments, if a base station changes the base station state, the active/valid group may be changed according to the change of the base station state.

### Aspect 4: UE Behavior

In some embodiments, the UE may perform, measure and/or transmit the CSI report according to the configure signal (e.g., RRC signaling) and/or the first signaling and/or predefined information.

In some embodiments, the TCI states of a semi-persistent CSI-RS or aperiofic CSI-RS is indicated by the first signaling or predefined information.

In some embodiments, a offset of a semi-persistent CSI-RS or aperiofic CSI-RS is indicated by the first signaling or predefined information.

In some embodiments, the offset is indicated in time domain resource assignment field.

In some embodiments, the UE is configured with a CSI-RS configuration or CSI report configuration associated with a group ID/index. In some embodiments, if the UE does not receive a first signaling indicating a CSI-RS configuration information (e.g., a group ID/index indication), the UE performs measurements and/or CSI report according to all the activated CSI-RS configuration. In some embodiments, if the UE does not receive a first signaling indicating a CSI-RS configuration information (e.g., a group ID/index indication), the UE performs measurements and/or CSI report according to the CSI-RS resource which is associated with a first kind of group ID/index, or the UE performs measurements and/or CSI report according to the CSI-RS resource which is not associated with a group ID/index and is activated. In some embodiments, the first kind of group ID/index is the group which includes a larger CSI-RS port number. In some embodiments, the first kind of group ID/index is group 0. In some embodiments, the first kind group ID/index is predefined.

In some embodiments, if the UE receives a first signaling indicating a CSI-RS configuration information or CSI report configuration, the indicated CSI-RS configuration information or CSI report configuration is applied/valid/activated at least after a time delay (also referred to as time period).

In some embodiments, if the UE receives a first signaling indicating a CSI-RS configuration information or CSI report configuration, the UE performs CSI-RS measurement according to the indicated CSI-RS configuration information at least after a first time delay (also referred to as first time period).

In some embodiments, if the UE receives a first signaling indicating a CSI-RS configuration information or CSI report configuration, the UE reports CSI according to the indicated CSI-RS configuration information or CSI report configuration at least after a second time delay (also referred to as second time period). In some embodiments, if the UE receives a first signaling indicating a CSI-RS configuration information, the UE reports CSI according to the indicated CSI-RS configuration information at least after a second time delay after receiving a valid CSI-RS.

In some embodiments, UE transmits CSI report at least after a valid CSI-RS configuration resource if the UE receives a first signaling indicating a CSI-RS configuration information or CSI report configuration or an activated group changes.

In some embodiments, if the UE changes active/valid group according to a predefined information, the corresponding group is applied/valid/activated at least after a time delay (also referred to as third time period). In some embodiments, if the UE changes active/valid group according to a predefined information, the UE performs a CSI-RS measurement according to the corresponding group after a first time delay (also referred to as fourth time period). In some embodiments, if the UE changes active/valid group according to a predefined information, the UE report CSI according to the corresponding group at least after a second time delay (also referred to as fifth time period).

The first time delay may be less than or equal to the second time delay.

The time delay/first time delay/second time delay may be associated with at least one of the following: a predefined value, a time domain behavior, a UE capability, a SFN (system frame number), a SCS, a ACK, a FR (frequency range) type, PUSCH processing time, a CSI computation time, a PDSCH processing time, a BWP switching delay, a high layer signaling. In some embodiments, the time delay is same as the time period or the third time period. In some embodiments, the first time delay is same as the first time period or the fourth time period. In some embodiments, the second time delay is same as the second time period or the fifth time period.

In some embodiments, the time delay/first time delay/second time delay is configured by a high layer signaling.

In some embodiments, the time delay/first time delay/second time delay is associated with at least a UE capability and a predefined value. For example, different UE capability may associate with different predefined value.

In some embodiments, the time delay/first time delay/second time delay is associated with at least a SFN. For example, the CSI-RS configuration or CSI report configuration in an activated group are valid from the first slot in a SFN after the SFN in which UE receives the first signaling or group changes according to a predefined information.

In some embodiments, the time delay/first time delay/second time delay is associated with at least a ACK. For example, the CSI-RS configuration or CSI report configuration in an activated group are valid after UE transmit an ACK for the first signaling. In another example, the CSI-RS configuration or CSI report configuration in an activated group are valid after N symbols/slot/milliseconds/sub-frame after UE transmit an ACK for the first signaling.

In some embodiments, the time delay/first time delay/second time delay is associated with at least a BWP switching delay. For example, the CSI-RS configuration or CSI report configuration in an activated group are valid after a BWP switching delay.

In some embodiments, the time delay/first time delay/second time delay is associated with at least a FR type. For example, the time delay/first time delay/second time delay for FR 1 is less than the time delay/first time delay/second time delay for FR 2.

In some embodiments, the time delay/first time delay/second time delay is associated with at least a PUSCH processing time. For example, the time delay/first time delay/second time delay is larger than or equal to the PUSCH processing time.

In some embodiments, the time delay/first time delay/second time delay is associated with at least a CSI computation time. For example, the time delay/first time delay/second time delay is larger than or equal to the CSI computation time.

In some embodiments, the time delay/first time delay/second time delay is associated with at least a PDSCH processing time. For example, the time delay/first time delay/second time delay is larger than or equal to the PDSCH processing time.

In some embodiments, the time delay/first time delay/second time delay is different for different time domain behavior CSI-RS resources. The time domain behavior includes ‘aperiodic’, ‘semi-persistent’, ‘periodic’. For example, the first time delay for ‘aperiodic’ CSI-RS resource is greater than the first time delay for ‘semi-persistent’ CSI-RS resource, and the first time delay for ‘semi-persistent’ CSI-RS resource is greater than the first time delay for ‘periodic’ CSI-RS resource.

In some embodiments, the time delay/first time delay/second time delay is different for different time domain behavior CSI reports.

In some embodiments, the time delay/first time delay/second time delay is a predefined value. The predefined value may be N symbols/slots/sub-frame/millisecond.

In some embodiments, the predefined value is N symbols/slots, the SCS of the predefined value is based on at least one of the following:
the smallest SCS among all active BWP,
the smaller SCS between a DL BWP in which the first signaling is received and the UL BWP in which a CSI report is transmitted,
the smallest SCS among a DL BWP in which the first signaling is received, a DL BWP in which the indicated CSI-RS resource is configured, and the UL BWP in which a CSI report is transmitted,
a predefined SCS,
the SCS of a DL BWP in which the first signaling is received,
the SCS of a DL BWP in which the indicated CSI-RS resource is configured or a CSI-RS is received,
the SCS of the UL BWP in which a CSI report is transmitted,
the SCS of a scheduling cell, and/or
the SCS of a scheduled cell.

In some embodiments, if the UE receives a first signaling indicating a CSI-RS configuration information indication or changes active/valid group according to a predefined information, during the time delay/first time delay/second time delay, the UE does not measure on CSI-RS which will be not activated after the time delay/first time delay/second time delay according to the CSI-RS configuration information indication or predefined information.

In some embodiments, if the UE receives a first signaling indicating a CSI-RS configuration information indication or changes active/valid group according to a predefined information, during the time delay/first time delay/second time delay, the UE will not report the CSI if the CSI is determined based on a CSI-RS which will be not activated after the time delay/first time delay/second time delay according to the CSI-RS configuration information indication or predefined information.

In some embodiments, if the UE receives a first signaling indicating a CSI-RS configuration information indication or changes active/valid group according to a predefined information, UE drops the CSI report. In some embodiments, if the UE receives a first signaling indicating a CSI-RS configuration information indication or changes active/valid group according to a predefined information, UE does not transmit a CSI report which is generated before the changing.

In some embodiments, if the UE receives a first signaling indicating a CSI-RS configuration information or changes active/valid group according to a predefined information, the activated/valid CSI-RS configuration may be activated at a different time for different time domain behavior. For aperiodic CSI-RS configuration included in the activated CSI-RS resource, the aperiodic CSI-RS resource is activated starting after a time delay and ending at the end of the scheduled PUSCH containing the report associated with the aperiodic CSI-RS. For semi-persistent CSI-RS configuration or periodic CSI-RS configuration included in the activated CSI-RS resource, the semi-persistent CSI-RS configuration or periodic CSI-RS configuration is activated starting after a time delay and ending at the slot of when a deactivation indication is applied.

In some embodiments, the UE receives a first signaling indicating a CSI-RS configuration information, and the CSI-RS configuration information is a group index indication, or a group index activation/de-activation indication. If the indicated CSI-RS configuration information includes a group index for which UE is not configured, the UE ignores the corresponding indication.

For one example, the UE is configured with group {0,1}, if the UE receives a first signaling indicating activate group {2}, then the UE ignores the indication.

For another example, the UE is configured with group {0,1}, if the UE receives a first signaling indicating activate group {2}, then the UE de-activates the group {0,1}.

In some embodiments, the UE receives a first signaling indicating a CSI-RS configuration information, and the CSI-RS configuration information is a group index indication, or a group index activation/de-activation indication. If the indicated CSI-RS configuration information includes a group index for which the UE is not configured, the UE uses a baseline group.

In some embodiments, the UE receives a first signaling which indicates a CSI-RS configuration indication. The CSI-RS configuration indication may only be valid for a CSI-RS resource or a CSI-RS configuration with second kind time domain behavior. For example, the second kind time domain behavior may be semi-persistent or periodic. For another example, the second kind time domain behavior includes at least aperiodic.

In some embodiments, the UE receives a first signaling which indicates a CSI-RS configuration indication. The CSI-RS configuration indication may only be valid for a CSI-RS resource or a CSI-RS configuration with second kind usage. The usage includes Channel Measurement (CSI report configuration configured with resourcesForChannelMeasurement), interference measurement (CSI report configuration configured with CSI-IM-ResourcesForInterference), rate matching (configured with ZP-CSI-RS-Resource) or intra cell interference measurement (CSI report configuration configured with nzp-CSI-RS-ResourcesForInterference). For example, the second kind usage includes at least channel measurement. For another example, the second kind usage includes at least one of the following: channel measurement and intra cell interference measurement, and rate matching.

In some embodiments, the UE receives a first signaling which indicates a CSI-RS configuration indication. The CSI-RS configuration indication may only be valid for a CSI report configuration configured with second kind time domain behavior. The time domain behavior for a CSI report configuration includes ‘aperiodic’, ‘semiPersistentOnPUCCH’, ‘semiPersistentOnPUSCH’, or ‘periodic’. For example, the second kind time domain behavior includes at least ‘aperiodic’.

In some embodiments, a first signaling is a DCI and a MAC CE. DCI is used to indicate CSI-RS configuration indication for semi-persistent CSI-RS configuration or aperiodic CSI-RS configuration. And MAC CE is used to indicate CSI-RS configuration indication for semi-persistent CSI-RS configuration or periodic CSI-RS configuration.

In some embodiments, one of the CSI measurement report configurations and a corresponding configuration in the CSI-RS configuration information are activated correspondingly. In an embodiment, the one of the CSI measurement report configurations and the corresponding configuration in the CSI-RS configuration information activated together. In an example, if the corresponding configuration in the CSI-RS configuration information is activated by a first signaling, the one of the CSI measurement report configurations is implicit activated. In another example, if one of the CSI measurement report configurations is activated by a first signaling, a corresponding configuration in the CSI-RS configuration information is implicit activated.

In some embodiments, CSI measurement report also referred to as CSI report or CSI.

### Aspect 5: UE Capability

In some embodiments, the UE reports UE capability to the gNB. The UE capacity may include at least one of the following: whether or not support group index/ID indication, whether or not support a CSI-RS configuration indication by DCI, whether or not support a CSI-RS configuration indication by MAC CE, whether or not terminal support a CSI-RS configuration indication, whether or not support configured with a group index/ID, the support number of group, the maximum number of group which is supported, and/or number of ports number types that can be reported at the same time or same slot.

In some embodiments, UE capability is transmitted by MAC CE or BSR (buffer status report) or CSI report or SRS (sounding reference signal) or RRC signaling.

### Aspect 6: UE Assistance Information

In some embodiments, the UE reports UE assistance information to the gNB. The UE assistance information may include at least one of the following: preferred group index/ID, preferred group, preferred number of group, preferred maximum number of group, preference of falling to a baseline group or a root group, preferred number of group, preferred maximum number of group, preferred maximum number of port, preferred to fallback to a baseline group, preferred to switch to a power saving state, preferred TCI (Transmission Configuration Indicator) state, a preferred beam indication.

In some embodiments, the UE assistance information is transmitted via UCI, PUSCH, or a UL MAC CE signaling. In some embodiments, the UE assistance information is transmitted by MAC CE or BSR (buffer status report) or CSI report or SRS (sounding reference signal) or RRC signaling.

In some embodiments, the UE transmits the UE assistance information after at least one of the following events occur: a beam failure, transmission of a preamble, a RACH procedure, receiving a CSI-RS configuration indication, a BWP switching.

### Aspect 7: Enablement

In some embodiments, the first signaling indication or group change according to a predefined information is enabled if an event occurs. In some embodiments, the first signaling indication is enabled means the gNB can transmit first signaling to the UE. In some embodiments, the first signaling indication is enabled means the UE will monitor the first signaling. In some embodiments, the first signaling indication is enabled means gNB can transmit first signaling with the CSI-RS configuration indication to UE. In some embodiments, the first signaling indication is enabled means the field is existing.

In some embodiments, the event includes at least one of the following:
A RRC signaling is configured to enable the first signaling indicates the CSI-RS configuration;
A group index/ID is configured;
An RRC signaling is configured to enable group change according to a predefined information;
A predefined information is configured (e.g., a timer is configured); and/or
An RRC signaling which enables the group indication is enabled or configured.

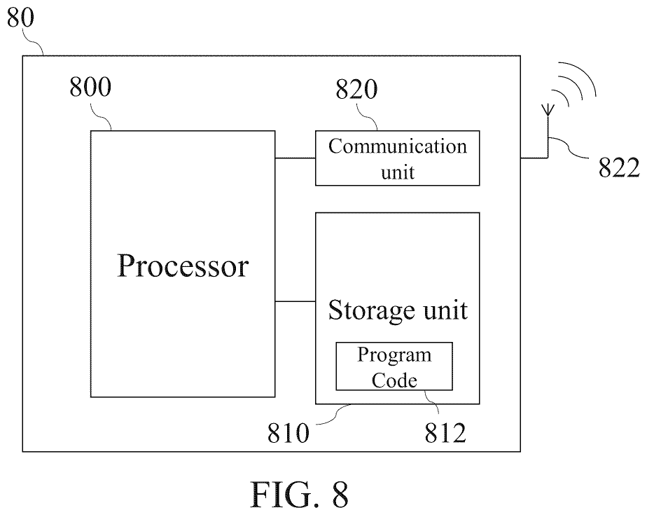

FIG. 8 relates to a schematic diagram of a wireless terminal 80 according to an embodiment of the present disclosure. The wireless terminal 80 may be a user equipment (UE), a mobile phone, a laptop, a tablet computer, an electronic book or a portable computer system and is not limited herein. The wireless terminal 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 812 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g. messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the wireless terminal 80, e.g., by executing the program code 812.

The communication unit 820 may be a transceiver. The communication unit 820 may as an alternative or in addition be combining a transmitting unit and a receiving unit configured to transmit and to receive, respectively, signals to and from a wireless network node (e.g. a base station).

In some embodiment, the wireless terminal 80 may be used to perform the operations of the UE described above. In some embodiments, the processor 800 and the communication unit 820 collaboratively perform the operations described above. For example, the processor 800 performs operations and transmit or receive signals through the communication unit 820.

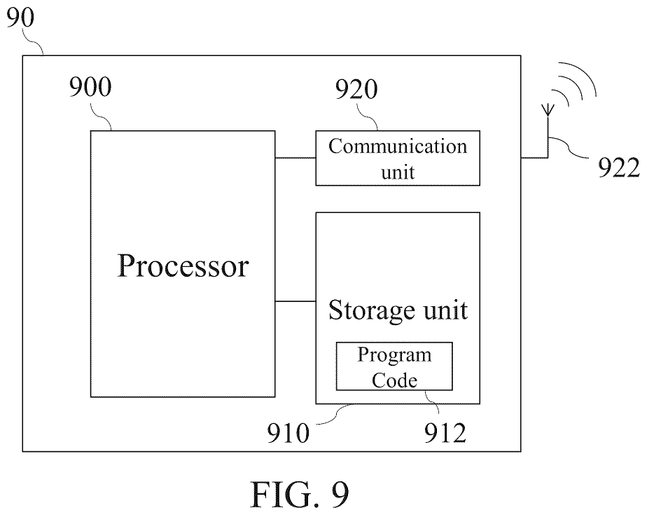

FIG. 9 relates to a schematic diagram of a wireless network node 90 according to an embodiment of the present disclosure. The wireless network node 90 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 90 may comprise (perform) at least one network function such as an access and mobility management function (AMF), a session management function (SMF), a user place function (UPF), a policy control function (PCF), an application function (AF), etc. The wireless network node 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 912 include but are not limited to a SIM, ROM, flash memory, RAM, hard-disk, and optical data storage device. The communication unit 920 may be a transceiver and is used to transmit and receive signals (e.g. messages or packets) according to processing results of the processor 900. In an example, the communication unit 920 transmits and receives the signals via at least one antenna 922 shown in FIG. 9.

In an embodiment, the storage unit 910 and the program code 912 may be omitted. The processor 900 may include a storage unit with stored program code.

The processor 900 may implement any steps described in exemplified embodiments on the wireless network node 90, e.g., via executing the program code 912.

The communication unit 920 may be a transceiver. The communication unit 920 may as an alternative or in addition be combining a transmitting unit and a receiving unit configured to transmit and to receive, respectively, signals to and from a wireless terminal (e.g. a user equipment or another wireless network node).

In some embodiment, the wireless network node 90 may be used to perform the operations of the gNB or base station described above. In some embodiments, the processor 900 and the communication unit 920 collaboratively perform the operations described above. For example, the processor 900 performs operations and transmit or receive signals through the communication unit 920.

In accordance with some embodiments of the present disclosure, a wireless communication method includes: receiving, by a wireless communication terminal (e.g., the UE described above) from a wireless communication node (e.g., the gNB or base station described above), control signaling comprising one or more channel state information reference signal, CSI-RS, configuration information associated with one or more group identifiers, IDs, (e.g., group ID/index described above) or one or more channel state information, CSI, measurement report configurations associated with one or more group IDs; receiving, by the wireless communication terminal from the wireless communication node, first signaling comprising a CSI-RS configuration indication; and performing, by the wireless communication terminal, at least one of a CSI-RS measurement or a transmission of a channel state information, CSI, measurement report to the wireless communication node based on at least one of the control signaling, the CSI-RS configuration indication, or predefined information.

In accordance with some embodiments of the present disclosure, a wireless communication method includes: transmitting, by a wireless communication node to a wireless communication terminal, control signaling comprising one or more channel state information reference signal, CSI-RS, configuration information associated with one or more group identifiers, IDs, or one or more channel state information, CSI, measurement report configurations associated with one or more group IDs; transmitting, by the wireless communication node to the wireless communication terminal, first signaling comprising a CSI-RS configuration indication; and receiving, by the wireless communication node from the wireless communication terminal, a channel state information, CSI, measurement report to the wireless communication node based on at least one of the control signaling, the CSI-RS configuration indication, or predefined information.

In an embodiment, the control signaling may be the high layer signaling described above which includes at least one of the CSI-RS configuration information, the CSI (measurement) report configuration, and/or the group ID/index described above.

In an embodiment, the association between the CSI-RS configuration information and the one or more group IDs may include the associations between the configurations in the CSI-RS configuration information and the group ID/index described above.

In an embodiment, the association between the CSI measurement report configurations and the one or more group IDs may include the associations between the CSI measurement report configurations and the group ID/index specified in the embodiments above.

In an embodiment, the CSI-RS configuration indication can include the indications or information in the first signaling described above.

Details of these wireless communication methods can be ascertained by referring to the embodiments above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

I/We claim:

1. A wireless communication method comprising:
receiving, by a wireless communication terminal from a wireless communication node, control signaling comprising one or more channel state information reference signal, CSI-RS, configuration information associated with one or more group identifiers, IDs, or one or more channel state information, CSI, measurement report configurations associated with one or more group IDs, and at least one of Radio Resource Control, RRC, signaling or Medium Access Control Control Element, MAC CE, signaling;
receiving, by the wireless communication terminal from the wireless communication node, first signaling comprising a CSI-RS configuration indication; and
performing, by the wireless communication terminal, at least one of a CSI-RS measurement or a transmission of a channel state information, CSI, measurement report to the wireless communication node based on at least one of the control signaling, the CSI-RS configuration indication, or predefined information.

2. The wireless communication method of claim 1, wherein the one or more group IDs is associated with at least one of: the CSI-RS configuration information, a CSI measurement report configuration, a CSI resource configuration, a CSI measurement configuration, a CSI-RS resource set, a CSI-RS resource, or a CSI-RS resource mapping.

3. The wireless communication method of claim 1, wherein the one or more group IDs is associated with at least one of periodic CSI-RS configuration information, aperiodic CSI-RS configuration information, or semi-persistent CSI-RS configuration information.

4. The wireless communication method of claim 1, wherein the one or more group IDs is associated with at least one of:
a periodic CSI measurement report, an aperiodic CSI measurement report, or a semi-persistent CSI measurement report;
report quantities of at least one of: none, cri-RI-PMI-CQI, cri-RI-i1, cri-RI-i1-CQI, pdsch-BundleSizeForCSI, cri-Ri-CSI, cri-RSRP, ssb-Index-RSRP, or cri-RI-LI-PMI-CQI; or
the CSI measurement report configuration for at least one of: a channel measurement, an interference measurement, a rate matching, or an intra cell interference measurement.

5. The wireless communication method of claim 1, wherein group IDs in the one or more group IDs associated with CSI-RS resources in one CSI-RS resource set are the same.

6. The wireless communication method of claim 1, wherein CSI-RS configurations associated with different group IDs in the one or more group IDs have a hierarchical relationship therebetween.

7. The wireless communication method of claim 6, wherein at least one of a first time and frequency domain resource, a first CDM group, a first density, or a first CDM group index for a first CSI-RS configuration corresponding to a first group ID in the one or more group IDs is a subset of at least one of a second time and frequency domain resource, a second CDM group, a second density, or a second CDM group index for a second CSI-RS configuration corresponding to a second group ID in the one or more group IDs.

8. The wireless communication method of claim 7, wherein the first CSI-RS configuration corresponding to the first group ID is associated with a first port number, the second CSI-RS configuration corresponding to the second group ID is associated with a second port number, and the first port number is less than the second port number.

9. The wireless communication method of claim 1, wherein a power control offset for a first CSI-RS configuration corresponding to a first group ID in the one or more group IDs is less than a power control offset for a second CSI-RS configuration corresponding to a second group ID in the one or more group IDs.

10. The wireless communication method of claim 9, the power control offset configured for a CSI RS resource in a first group corresponding to the first group ID reduces 10*log₁₀(P1/P2) dB from the power control offset configured for a CSI RS resource in a second group corresponding to the second group ID, wherein P1 is a port number configured for the CSI RS resource in the second group, P2 is a port number configured for the CSI RS resource in the first group, and P1 is larger than P2.

11. The wireless communication method of claim 1, wherein the first signaling indicates a CSI-RS configuration indication, the CSI-RS configuration indication comprises at least one of: a group ID indication, a group activation or deactivation indication, a base station state indication, an antenna number indication, an aperiodic CSI-RS resource activation indication, an aperiodic CSI measurement report activation indication, or a semi-persistent CSI-RS resource activation indication.

12. The wireless communication method of claim 1, wherein the first signaling comprises at least one of: common downlink control information, DCI, dedicate DCI, broadcast DCI, multicast DCI, an MAC CE, or a system information block, SIB.

13. The wireless communication method of claim 1, wherein the predefined information comprises at least one of: one or more timers, a predefined pattern, or a base station state.

14. The wireless communication method of claim 1, wherein the wireless communication terminal performs at least one of the following operations:
applying, validating or activating the CSI-RS configuration information after a time period relative to the reception of the first signaling;
performing the CSI-RS measurement based on the CSI-RS configuration information after a first time period relative to the reception of the first signaling;
performing the transmission of the CSI measurement report based on the CSI-RS configuration information after a second time period relative to the reception of the first signaling;
changing an activated group according to the predefined information, wherein a corresponding group is applied, validated, or activated after a third time period relative to the change of the activated group;
performing a CSI-RS measurement according to the CSI-RS configuration information in the corresponding group after a fourth time period relative to the change of the activated group; or
performing a transmission of a CSI measurement report for the CSI-RS configuration information or CSI measurement report configuration in the corresponding group after a fifth time period.

15. The wireless communication method of claim 1, wherein when the CSI-RS configuration indication indicates a group ID that the wireless communication terminal is not configured with, the wireless communication terminal ignores the CSI-RS configuration indication, or performs the measurement based on a baseline group, or performs the transmission of the CSI measurement report based on a baseline group.

16. The wireless communication method of claim 1, wherein the CSI-RS configuration indication is valid when the CSI-RS configuration information in a group which activated by the CSI-RS configuration indication is for at least one of: channel measurement, interference measurement, rate matching, or intra cell interference measurement.

17. The wireless communication method of claim 1, wherein the CSI-RS configuration indication is valid when the time domain behavior of the CSI-RS configuration information or CSI measurement report configurations in a group which activated by the CSI-RS configuration indication is at least one of: aperiodic, semi-persistent, or periodic.

18. The wireless communication method of claim 1, wherein the CSI measurement report configurations and a corresponding configuration in the CSI-RS configuration information are activated correspondingly.

19. A wireless communication method comprising:
transmitting, by a wireless communication node to a wireless communication terminal, control signaling comprising one or more channel state information reference signal, CSI-RS, configuration information associated with one or more group identifiers, IDs, or one or more channel state information, CSI, measurement report configurations associated with one or more group IDs;
transmitting, by the wireless communication node to the wireless communication terminal, first signaling comprising a CSI-RS configuration indication; and
receiving, by the wireless communication node from the wireless communication terminal, a channel state information, CSI, measurement report to the wireless communication node based on at least one of the control signaling, the CSI-RS configuration indication, or predefined information.

20. A wireless communication terminal, comprising:
a communication unit; and
a processor configured to: receive, from a wireless communication node, control signaling comprising one or more channel state information reference signal, CSI-RS, configuration information associated with one or more group identifiers, IDs, or one or more channel state information, CSI, measurement report configurations associated with one or more group IDs; receive, from the wireless communication node, first signaling comprising a CSI-RS configuration indication; and perform at least one of a CSI-RS measurement or a transmission of a channel state information, CSI, measurement report to the wireless communication node based on at least one of the control signaling, the CSI-RS configuration indication, or predefined information.
